(19) United States
(12) Patent Application Publication
(10) Pub. No.: US 2018/0307626 A1
(43) Pub. Date: Oct. 25, 2018

(54) HARDWARE-ASSISTED MEMORY ENCRYPTION CIRCUIT

(71) Applicant: Oracle International Corporation, Redwood City, CA (US)

(72) Inventor: Stephen A. Chessin, Mountain View, CA (US)

(21) Appl. No.: 15/492,066

(22) Filed: Apr. 20, 2017

(51) Int. Cl. G06F 12/14; H04L 29/06; G06F 12/0811

(52) U.S. Cl. CPC G06F 12/1408; H04L 63/061; G06F 2212/283; G06F 2212/1052; G06F 12/0811

(57) ABSTRACT

In some embodiments, an integrated circuit includes a memory hierarchy including at least a first memory and a second memory. The integrated circuit further includes an encryption management circuit configured to receive information in a first format from the first memory. The encryption management circuit may perform a cryptographic operation on the information to convert the information from the first format to a second format. The encryption management circuit may output the information to the second memory.

### BACKGROUND

Computer systems commonly organize memory in a hierarchy having various levels. These memory levels may include, in various embodiments, a register file and one or more caches. This organization may lead to data security issues in some instances. Exchange of data between these levels, for example, may present an opportunity for unauthorized access by a potential interceptor. Similarly, memory data values may also be susceptible to being read by an interceptor at different locations in a memory hierarchy.

### SUMMARY

In various embodiments of the systems described herein, an integrated circuit may include a first memory and a second memory, where the first memory and second memory are different parts of a memory hierarchy. As part of a memory operation (e.g., sending data from the first memory to the second memory), an encryption management circuit (EMC) may receive information from the first memory. The information may be in a first format (e.g., an encrypted format). The encryption management circuit may convert the information from the first format into a second format (e.g., an unencrypted format). The encryption management circuit may send the information having the second format to the second memory. Accordingly, the EMC may change an encryption level of information transmitted within the integrated circuit.

### BRIEF DESCRIPTION OF THE DRAWINGS

FIG. 1 is a block diagram illustrating one embodiment of a system that includes an encryption management circuit (EMC).

FIG. 2 is a block diagram illustrating one embodiment of an EMC.

FIG. 3 is a block diagram illustrating a relationship between an EMC and various levels of a memory hierarchy in one embodiment.

FIG. 4 is a flow diagram illustrating one embodiment of a method performed with an EMC on information in a memory hierarchy, in accordance with the disclosed embodiments.

FIG. 5 is a flowchart illustrating one embodiment of a method of performing a cryptographic operation with an EMC.

FIG. 6 is a flowchart illustrating one embodiment of a method of performing a cryptographic operation.

FIG. 7 is a block diagram illustrating an embodiment of an exemplary computing system that includes an EMC.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation [entity] configured to [perform one or more tasks] is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a processing circuit that includes six memory devices, the terms “first memory device” and “second memory device” can be used to refer to any two of the six memory devices, and not, for example, just logical memory devices 0 and 1.

When used in the claims, the term “or” is used as an inclusive or and not as an exclusive or. For example, the phrase “at least one of x, y, or z” means any one of x, y, and z, as well as any combination thereof (e.g., x and y, but not z).

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION

A hardware-assisted memory encryption circuit is disclosed that may perform a cryptographic operation (e.g., encrypt, decrypt, or both) upon data that is being sent between two levels of a memory hierarchy. As a result, data stored within a memory hierarchy of an integrated circuit may be encrypted, as compared to systems where data is only decrypted when it is received from an external source (e.g., an off-chip memory device). In some embodiments, the cryptographic operation may differ (e.g., a different encryption algorithm may be used) for different data sets. For example, a first data set sent from a level 2 (L2) cache to a level (L1) cache may be converted from a first (e.g., encrypted) format to a second (e.g., unencrypted) format. A second data set from the L2 cache may be converted from a third format to the second format. In various embodiments, the cryptographic operation may be determined based on a memory address of the data. Accordingly, data may be stored in one or more encrypted states within various levels of the memory hierarchy. As a result, the data may be more secure, as compared to a system where the data is not encrypted when it is in the memory hierarchy.

As used herein, “memory location” is used to refer to a physical data storage location within a memory device. The memory location has a corresponding physical memory address, and, in some cases, a virtual memory address.

As described above, cryptographic operations are performed on data that is sent from one level of a memory hierarchy to another level. As used herein, “origin memory location” refers to a source location of the data transmission. Further, as used herein, “destination memory location,” refers to an addressed destination location of the data transmission. For example, a transfer of data from a L2 memory cache to a L1 memory cache refers to sending data from an origin memory location within the L2 memory cache to a destination memory location within the L1 memory cache. As described herein, information associated with an origin memory location may identify a device that includes the origin memory location, a physical address within the origin memory location, or both.

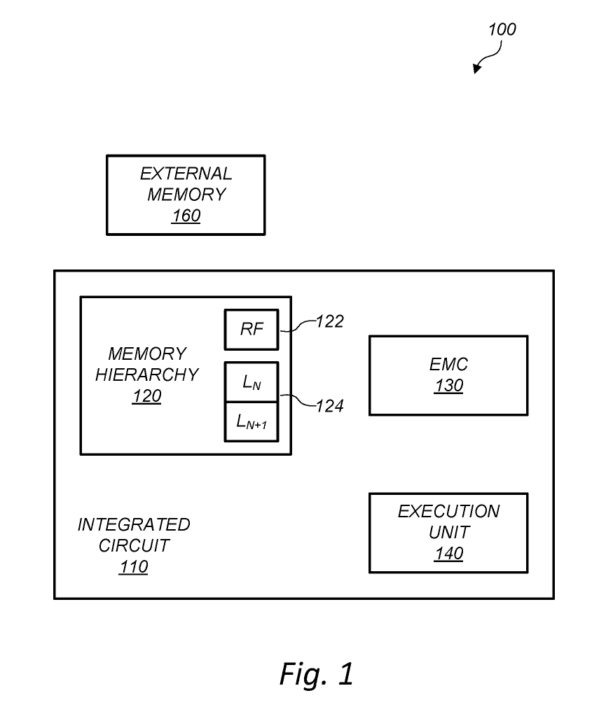

Referring now to FIG. 1, a block diagram illustrating an exemplary system 100 that includes a hardware-assisted memory encryption circuit is shown. In the illustrated embodiment, the system 100 includes an integrated circuit 110 and an external memory 160. The integrated circuit 110 includes an encryption management circuit (EMC) 130, a memory hierarchy 120, and an execution unit 140. As discussed herein, the memory hierarchy 120 includes a plurality of levels of memory including a register file 122 and a cache hierarchy 124. Although various portions of the system 100 are illustrated together for clarity reasons, a variety of structural arrangements may be used. For example, in some embodiments, register file 122 may be part of execution unit 140. Similarly, in some embodiments, EMC 130 may be part of one or more levels of cache hierarchy 124. The various components of the integrated circuit 110 may be portions of a single integrated circuit in a system on a chip (SOC) arrangement. In various embodiments, the integrated circuit 110 may include additional components not shown in FIG. 1 such as a various input and output components, digital processing components, analog processing components, timing components, voltage regulators, power management components, additional memory hierarchies, EMCs, execution units, or any combination thereof. In some embodiments, multiple instances of various devices may be included. For example, in some embodiments, integrated circuit 110 may include multiple EMCs (e.g., corresponding to different sets of levels of cache hierarchy 124).

In the illustrated embodiment, cache hierarchy 124 includes a plurality of cache levels 124₀, 124₁, 124₂, 124_{N} corresponding to the various levels of the cache L0, L1, L2, LN. However, in other embodiments, one or more levels (e.g., L0 or L2) may not be included. Memory devices of the cache hierarchy 124 may include volatile and/or nonvolatile memory (e.g., L0 and L1 may be volatile and L2-LN may be nonvolatile; L0-LN may be nonvolatile, etc.). For example, the cache hierarchy 124 may include on-chip RAM (e.g. DRAM, SRAM, etc.), on-chip programmable ROM (PROM, EPROM. EEPRIM), and/or on-chip NVRAM (e.g., flash memory). In the illustrated embodiment, each level of the cache hierarchy 124 may be faster (and smaller in capacity) than the levels below it. For example, the L0 cache 124₀ may be the fastest and smallest level of the cache hierarchy 124 (e.g., sized 5-10 kilobytes), the L1 cache 124₁ may be slower than the L0 cache but larger in capacity (e.g., 100 kilobytes), the L2 cache 124₂ may be slower than the L1 cache 124₁ and around the same size as the L1 cache 124₁ (e.g., 100 kilobytes), the L3 cache 124₃ maybe slower still but substantially larger in capacity (e.g., 1 megabyte), etc. However, other implementations of cache hierarchies are also considered (e.g., implementations where the L1 cache 124₁ is the same size as the L2 cache 124₂). Accordingly, in various embodiments, the cache hierarchy 124 may include any number of cache levels 124_{N} and that the individual cache levels 124_{N} may have different access speeds and capacities than the examples given herein.

In the illustrated embodiment, execution unit 140 may request data from memory hierarchy 120. If the data is not stored in register file 122, a first level of cache hierarchy 124 (e.g., L1 cache 124₁) may be checked for the data. If the data is not stored in the first level of cache hierarchy 124, other levels of cache hierarchy 124 may be successively checked for the data. If the data is not stored in cache hierarchy 124, the data may be retrieved from external memory 160.

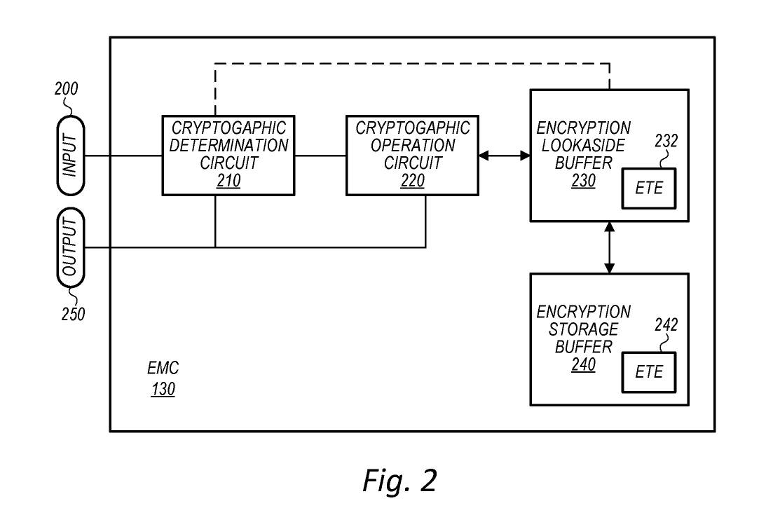

The EMC 130 may be used to perform cryptographic operations (e.g., encryption and decryption tasks) as discussed further below with reference to FIG. 2. In particular, EMC 130 may receive data from one memory device in memory hierarchy 120, perform a cryptographic operation on the data, and send the data to another level of memory hierarchy 120. In some embodiments, EMC 130 may only receive data from and send data to two levels of memory hierarchy 120 (e.g., L1 and L2). In other embodiments, EMC 130 may perform cryptographic operations on data being transferred between two of at least three levels of memory hierarchy 120. Accordingly, data may be stored in one or more encrypted states within various levels of memory hierarchy 120. As a result, the data may be more secure, as compared to unencrypted data that is stored in memory hierarchy 120. For example, it may be more difficult to read the data from memory devices (e.g., L3) where the data is stored in an encrypted format. Further, it may be more difficult to read the data (e.g., via bus snooping) as it is being transferred between two levels of memory hierarchy.

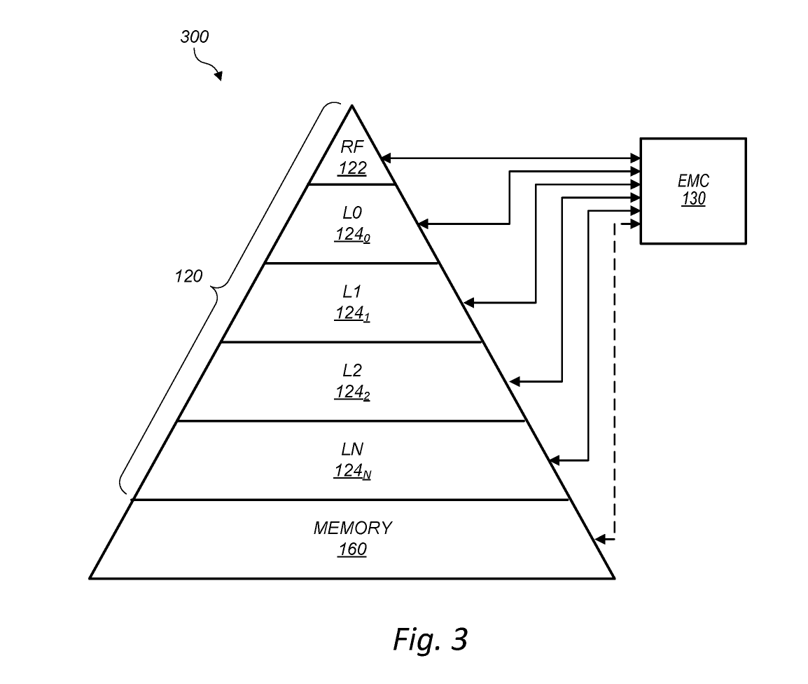

In the illustrated embodiment, as further discussed below with reference to FIG. 3, data stored at or above a particular level may have a first format. Data stored at or above a different level may have a second format. In some embodiments, data stored at or above a third level may have at third format. For example, data stored in register file 122 or in the L0 cache 124₀ cache may be stored in an unencrypted format. Data stored in the L1 cache 124₁ or the L2 cache 124₂ may be stored in a first encrypted format. Data stored in the L3 cache 124₃ or in external memory 160 may be stored in a second encrypted format. The second encrypted format may be a multiply encrypted format (e.g., resulting from encryption of encrypted data). Alternatively, the second encrypted format may be a singly encrypted format that is different from the first encrypted format.

The external memory 160 may include one or more memory devices external to the integrated circuit 110. For example, the external memory 160 may include any of a number of RAM circuits (e.g. dual in-line memory modules (DIMMs)), ROM circuits (e.g., ROM, PROM, EPROM, EEPROM), hard disk drives, solid state drives, flash memories, etc. or any combination thereof. In some embodiments, as discussed further below, external memory 160 may store data used by EMC 130 (e.g., one or more encryption table entries).

Referring now to FIG. 2, a block diagram illustrating various components of the EMC 130 is shown. The EMC 130 may include an input circuit 200, a cryptographic determination circuit 210, a cryptographic operation circuit 220, an encryption lookaside buffer (ELB) 230, an encryption storage buffer (ESB) 240, and an output circuit 250. In the illustrated embodiment, encryption lookaside buffer (ELB) 230 includes encryption table entry (ETE) 232. Further, encryption storage buffer (ESB) 240 includes ETE 242. The EMC 130 may be implemented as a discrete device of the integrated circuit 110, but the various components of the EMC 130 shown in FIG. 2 may also be distributed throughout the integrated circuit 110. For example, in some embodiments, ETEs 232 and 242 may be implanted as part of a single memory device. Further, in some embodiments, ETEs may be part of memory hierarchy 120 of FIG. 1. In some embodiments, some or all of the ESB 240 may be implemented in external memory 160 of FIG. 1.

The EMC 130 may include an input circuit 200 and an output circuit 250 to receive information and to transmit information, respectively. As disclosed herein, the EMC 130 may receive information from a particular memory location of the memory hierarchy 120 using the input circuit 200 and send information to another memory location of the memory hierarchy 120 using the output circuit 250. In some embodiments, the input circuit 200 and output circuit 250 may both include a plurality of lines, each coupled to a respective level of the memory hierarchy 120. As discussed herein with reference to FIG. 3, the EMC 130 may also be configured to receive data from and send data to an external memory 160. The input circuit 200 and the output circuit 250 may be discrete components, or they may be integrated into a single input/output circuit. As discussed herein, the information received at the input circuit 200 may be encrypted, multiply encrypted, or unencrypted. Further, the information sent by the output circuit 250 may be encrypted, multiply encrypted, or unencrypted. Accordingly, the information received at the input circuit 200 may be in a first format and the information coming out of the output circuit 250 may be in a second format. The first format may be different from the second format in cases where a cryptographic operation has been performed as discussed herein, or the first format and the second format may be identical where no cryptographic operation has been performed.

The cryptographic determination circuit 210 may determine whether to perform a cryptographic operation on the information received through the input circuit 200. In some embodiments, the cryptographic determination circuit 210 may base its determination on one or more of a memory address (e.g., a physical or virtual address) of the data, a memory level of the origin memory location, and/or a memory level of the destination memory location. For example, if the origin memory location of the received information is the register file 122 and the destination memory location of the received information is in the L0 cache 124₀, the cryptographic determination circuit 210 may determine to perform a first cryptographic operation on the received information. Similarly, if the origin memory location is in the L0 cache 124₀ and the destination memory location is the register file 122, the cryptographic determination circuit 210 may determine to perform a second cryptographic operation on the received information.

Alternatively or additionally, in some embodiments, the received information itself may indicate whether a cryptographic operation should be performed by, for example, having one or more flags within the received information (e.g., one or more bits at the beginning or end of the bit stream comprising the received information). Alternatively or additionally, the cryptographic determination circuit 210 may be configured to access the ELB 230 to access encryption information associated with the received information (e.g., based on an address of the received information, an origin memory location of the received information, or a destination memory location of the received information). Based on the encryption information, the cryptographic determination circuit 210 may determine that a cryptographic operation should be performed on the received information. If a cryptographic operation is to be performed (e.g., a flag received with the information indicates a cryptographic operation), the cryptographic determination circuit 210 may send the received information to the cryptographic operation circuit 220 for further processing. Additionally, in some embodiments, the cryptographic determination circuit 210 may provide the cryptographic operation circuit 220 with an indication of what kind of cryptographic operation should be performed (i.e., whether to encrypt, decrypt, or decrypt and re-encrypt the received information). If a cryptographic operation is not to be performed (e.g., a flag received with the information indicates no cryptographic operation), the cryptographic determination circuit 210 may send the received information to the output circuit 250 directly, bypassing the rest of the EMC 130. Alternatively, in some embodiments, the cryptographic determination circuit 210 may send the received information to the cryptographic operation circuit 220 with an indication that no cryptographic operation should be performed (e.g., because there is no connection between the cryptographic determination circuit 210 and the output circuit 250).

The cryptographic operation circuit 220 may perform a cryptographic operation (e.g., encrypting, decrypting, or decrypting and re-encrypting) on received information. In the illustrated embodiment, the cryptographic operation circuit 220 may be configured to perform cryptographic operations according to a plurality of different encryption algorithms. In some embodiments, the different encryption algorithms may be stored as a list of encryption algorithms (not shown) and may be used to determine which encryption algorithm should be performed on the received information. Alternatively, the cryptographic operation circuit 220 may only be configured to perform cryptographic operations according to a single encryption algorithm. In various embodiments, a selected cryptographic operation may involve an encryption key. As discussed herein, when performing a cryptographic operation on received information, the cryptographic operation circuit 220 may select or receive an indication of the appropriate encryption algorithm (e.g., to encrypt or decrypt the received information) and receive, determine, or generate the appropriate encryption key.

The cryptographic operation circuit 220 may be configured to perform various types of cryptographic operations (e.g., encrypting, decrypting, decrypting then re-encrypting). In a first non-limiting example, the received information may be in a first format that is an unencrypted format and the result of the cryptographic operation may be a second set of information in a second format that is an encrypted format (i.e., in the first non-limiting example the cryptographic operation encrypts the received information). In a second non-limiting example, the received information may be in a first format that is an encrypted format and the result of the cryptographic operation may be a second set of information in a second format that is an unencrypted format (i.e., in the second non-limiting example the cryptographic operation decrypts the received information). In a third non-limiting example, the received information may be in a first format that is a multiply encrypted format and the result of the cryptographic operation may be a second set of information in a second format that is also encrypted, but having one fewer layer of encryption (e.g., a doubly encrypted format is decrypted to a singly encrypted format). In a fourth non-limiting example, the received information may be in a first format that is an encrypted format (e.g., singly encrypted, multiply encrypted) and the result of the cryptographic operation may be a second set of information in a second format that is also encrypted, but having one more layer of encryption (e.g., a singly encrypted format is encrypted to a doubly encrypted format). In a fifth non-limiting example, the received information may be in a first format that is an encrypted format and the result may be a second set of information in a second format that is also encrypted but is encrypted using a different encryption algorithm and/or different encryption key than the first format and in which the received information is decrypted before being re-encrypted to the second format.

As noted above, the cryptographic operation circuit 220 may be configured to receive an indication from the cryptographic determination circuit 210 specifying which kind of cryptographic operation (e.g., encryption, decryption, decryption and re-encryption) the cryptographic operation circuit 220 should perform on the received data. This indication, for example, may be a series of bits appended to the received information. Alternatively, the cryptographic operation circuit 220 may be configured to access the ELB 230 to access encryption information associated with the origin memory location, the destination memory location, an address (e.g., a physical address or a virtual address) of the data, or any combination thereof. The cryptographic operation circuit 220 may determine, based on the encryption information, which type of cryptographic operation to perform on the received data (e.g., by checking a flag, checking an indicator of an encryption algorithm associated with the received data, checking an indicator of an encryption key associated with the received data, etc.). Additionally or alternatively, the determination of which cryptographic operation to perform may be based in part on one or more of a memory level of the origin memory location of the received information, a memory level of the destination memory location of the received information, or an address of the data. For example, the cryptographic operation circuit 220 may decrypt received information in response to detecting that the origin memory location of the received information is the L0 cache 124₀ and the destination memory location is the register file 122. Similarly, the cryptographic operation circuit 220 may encrypt received information in response to detecting that the origin memory location of the received information is the register file 122 and the destination memory location is the L0 cache 124₀.

To perform a cryptographic operation, the cryptographic operation circuit 220 may access one or more components (e.g., the ELB 230, ESB 240) storing encryption information associated with the origin memory location of the received information, the destination memory location, an address of the data, or any combination thereof. As discussed herein, during decryption operations, the cryptographic operation circuit 220 may use the encryption information associated with the received information to decrypt the received information. During encryption operations, the cryptographic operation circuit 220 may update the encryption information associated with the received information such that the resulting information may be decrypted at a later time. The encryption information may be stored as an encryption table entry (ETE) 232 or an ETE 242. The ETE 232 or 242 may include some or all of information relating to (1) a virtual address of the received information, (2) an indicator of the encryption algorithm used to encrypt the received information, (3) an indicator of the encryption key used to encrypt the received information, (4) a cryptographic status indicator, (5) a physical address of the received information, (6) an origin memory location of the received information, and/or (7) a destination memory location of the received information. In some embodiments, the indicator of the encryption algorithm used may be a number of bits corresponding to a list of the one or more encryption algorithms implemented in the cryptographic operation circuit 220 hardware (e.g., 000 binary corresponding to a first encryption algorithm 001 binary corresponding to a second encryption algorithm, etc.). In various embodiments, the list of encryption algorithms may be stored in the EMC 130. Alternatively, the list of encryption algorithms may be stored in another circuit (e.g., a portion of the memory hierarchy 120). Alternatively or additionally, the indictor of the encryption algorithm may be a pointer to a location in the system memory hierarchy 300 indicating where the EMC 130 may access a copy of the encryption algorithm used. The indicator of the encryption key used to encrypt the received information may be the key itself (e.g., a series of bits representing the key), information indicating how to calculate or otherwise reproduce the key (e.g., a salt), or a pointer to a location in the system memory hierarchy 300 indicating where the EMC 130 may access a copy of the encryption key. The cryptographic status indicator may indicate whether the received information is unencrypted, encrypted, or multiply-encrypted (e.g., doubly-encrypted, triply-encrypted).

ETEs 232 and 242 may be stored in either or both of the ELB 230 and encryption storage buffer (ESB) 240. In some embodiments, ETEs 232 and 242 may be arranged in a memory hierarchy. Accordingly, the ELB 230 may store more frequently accessed ETEs 232 and ESB 240 may store less frequently accessed ETEs 242. In some embodiments, the ESB 240 may store more ETEs than the ELB 230, and the ELB 230 may be configured to fetch ETEs from the ESB 240 (e.g., in response to a request for an ETE that is not currently stored in the ELB 230). For example, in response to failing to find a particular ETE in the ELB 230, the EMC 130 may perform a hardware table walk to search the ESB 240. In response to failing to find the particular ETE via the hardware table walk, the EMC 130 may signal software to perform a software table walk to retrieve the ETE 232 for the received information from the memory hierarchy 120, system memory hierarchy 300, or external memory 160 and load it into the ESB 240, or create an appropriate ETE 232 if one cannot be retrieved. In some embodiments, the ELB 230 may be implemented in a first memory device (e.g., registers or in the cache hierarchy 124) and the ESB 240 may be implemented in a second memory device (e.g., an external memory such as external memory 160, in the cache hierarchy 124, or in another memory device of the integrated circuit 110).

In response to receiving the information on which to perform a cryptographic operation (e.g., from the cryptographic determination circuit 210) and the ETE associated with that information (e.g., from the encryption lookaside buffer (ELB) 230), the cryptographic operation circuit 220 may perform the cryptographic operation (e.g., decrypting the received information, encrypting the received information, decrypting and then re-encrypting the received information) and output the resulting information to the output circuit 250. As discussed herein, the cryptographic operation circuit 220 may also be configured to update the ETE 232 associated with the address of the information, the origin memory location, and/or the destination memory location. As discussed herein, the output circuit 250 may be configured to relay the resulting information to the appropriate memory location.

Referring now to FIG. 3, a block diagram illustrating the various levels of the system memory hierarchy 300 of some embodiments of the system 100 is shown. The system memory hierarchy 300 includes the various levels of one embodiment of the memory hierarchy 120 of the integrated circuit 110 arranged sequentially with the fastest and smallest levels of the memory hierarchy 120 at the top of the memory hierarchy (e.g., the register file 122) with the levels of the slower and larger cache hierarchy 124 below the register file 122 arranged in order from the L0 cache 124₀ to LN cache 124_{N}. However, in other embodiments, various other arrangements of hardware devices is also considered. For example a larger memory device may be higher in the system memory hierarchy 300 than a smaller memory device. It will be understood that in some embodiments, some portions of the illustrated cache hierarchy may not be present. For example, in some cases, the lowest level of the cache hierarchy 124 may be the L1 cache 124₁ with no L0 cache 124₀ being present. Additionally, it will also be understood that in some embodiments, intermediate layers of the cache hierarchy 124 may not be present (e.g., a system may have an L1 cache 124₁ and an L3 cache 124₃). The slower and larger still external memory 160 is shown below the cache hierarchy 124. As discussed above, the EMC 130 may be coupled to one or more levels of the memory hierarchy 120 of the integrated circuit 110. The EMC 130 may perform cryptographic operations on information sent between levels of the memory hierarchy 120. In some embodiments, the EMC 130 may also be coupled to the external memory 160. In such embodiments, the EMC 130 may be configured to perform cryptographic operations on information sent between the external memory 160 and one or more levels of the memory hierarchy 120. In some embodiments, data may only move between adjacent levels of the system memory hierarchy 300 (e.g., from the register file 122 to the L0 cache 124₀). Accordingly, the EMC 130 may only perform cryptographic operations on data moving between adjacent levels of the system memory hierarchy 300. Alternatively, in some embodiments, the EMC 130 may receive information from a memory level (e.g., from the register file 122) and may send the information to a nonadjacent memory level (e.g., to L1 124₁). In various embodiments, EMC 130 may be implemented as multiple separate devices and may be configured to receive information from one or more memory levels and send information to one or more memory levels.

### Example Methods

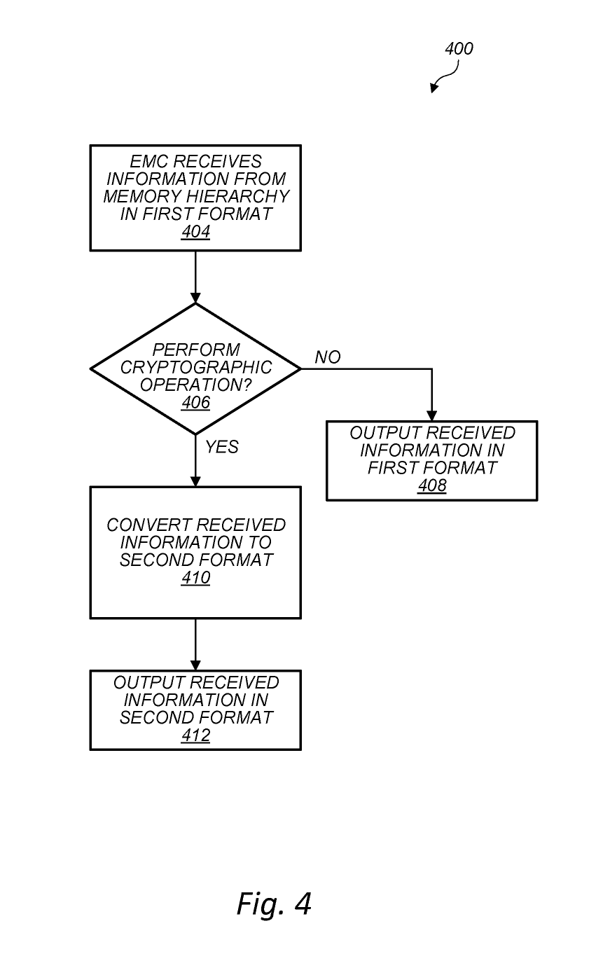

Referring now to FIG. 4, a flowchart illustrating one embodiment of a method 400 performed with an EMC 130 on information in a memory hierarchy 120 is shown. The method 400 includes blocks that represent various tasks performed by the EMC 130 (and the EMC 130's components). Because the EMC 130 may be implemented in hardware on an integrated circuit 110, the various tasks of the method 400 may be implemented using semiconductor logic. Such semiconductor logic may be hardwired into the EMC 130. Alternatively, some or all of the EMC 130 may have reprogrammable logic circuits. Further, other similar logic may instead be used.

At block 404, the EMC 130 receives information in a first format from an origin memory location in the memory hierarchy 120. The first format may be an unencrypted format, an encrypted format, or a multiply encrypted format. The origin memory location may be in the memory hierarchy 120 (e.g., in the register file 122 or one of the levels of the cache hierarchy 124). In some embodiments, the origin memory location may be in the external memory 160.

At block 406, the EMC 130 determines whether to perform a cryptographic operation on the received information. As discussed above with reference to FIG. 2, a cryptographic determination circuit 210 of the EMC 130 may analyze the received information, an address associated with the received information, encryption information associated with the received information, the origin memory location of the received information, and/or the destination memory location of the received information. The cryptographic determination circuit 210 may determine whether to perform a cryptographic operation on the information received through the input circuit 200. In some embodiments, the determination may be based at least in part on one or more of the address of the received information, a memory level of the origin memory location, and/or a memory level of the destination memory location. For example, if the origin memory location of the received information is the register file 122 and the destination memory location of the received information is the L0 cache 124₀, the cryptographic determination circuit 210 may always determine to perform a cryptographic operation on the received information. Similarly, if the origin memory location is the L0 cache 124₀ and the destination memory location is the register file 122, the cryptographic determination circuit 210 may always determine to perform a cryptographic operation on the received information. In some embodiments, the EMC 130 may always perform a cryptographic operation on received information, so, in some embodiments, block 406 may not be performed. Alternatively or additionally, the received information itself may indicate whether a cryptographic operation should be performed (e.g., via one or more flags within the received information). Alternatively or additionally, the cryptographic determination circuit 210 may access the ELB 230 to access encryption information associated with the memory location of the received information to see whether a flag is set in the encrypted information. In some embodiments, the cryptographic determination circuit 210 may provide the cryptographic operation circuit 220 with an indication of what kind of cryptographic operation should be performed (i.e., whether to encrypt or decrypt the received information).

At block 408, in response to determining to not perform a cryptographic operation on the received information, the EMC 130 may output the received information in the first format through the output circuit 250 to the destination memory location. For example, if the received information is encrypted, the output is encrypted.

At block 410, in response to determining to perform a cryptographic operation on the received information, the EMC 130 may convert the received data to a second format. In a first non-limiting example, the received information is in a first format that is an unencrypted format and the result of the cryptographic operation is a second set of information in a second format that is an encrypted format (i.e., in the first non-limiting example the cryptographic operation encrypts the received information). In a second non-limiting example, the received information is in a first format that is an encrypted format and the result of the cryptographic operation is a second set of information in a second format that is an unencrypted format (i.e., in the second non-limiting example the cryptographic operation decrypts the received information). In a third non-limiting example, the received information is in a first format that is a multiply encrypted format and the result of the cryptographic operation is a second set of information in a second format that is a also encrypted, but having one fewer layer of encryption (e.g., a doubly encrypted format is decrypted to a singly encrypted format). In a fourth non-limiting example, the received information is in a first format that is an encrypted format (e.g., singly encrypted, multiply encrypted) and the result of the cryptographic operation is a second set of information in a second format that is also encrypted, but having one more layer of encryption (e.g., a singly encrypted format is encrypted to a doubly encrypted format). In a fifth non-limiting example, the received information is in a first format that is an encrypted format and the result is a second set of information in a second format that is also encrypted but is encrypted using a different encryption algorithm and/or different encryption key than the first format and in which the received information is decrypted before being re-encrypted to the second format.

At block 412, the EMC 130 may output the received information in the second format (e.g., through the output circuit 250) to the destination memory location. The destination memory location may be in the memory hierarchy 120 (e.g., a register file 122, a level of the cache hierarchy 124) or in the external memory 160.

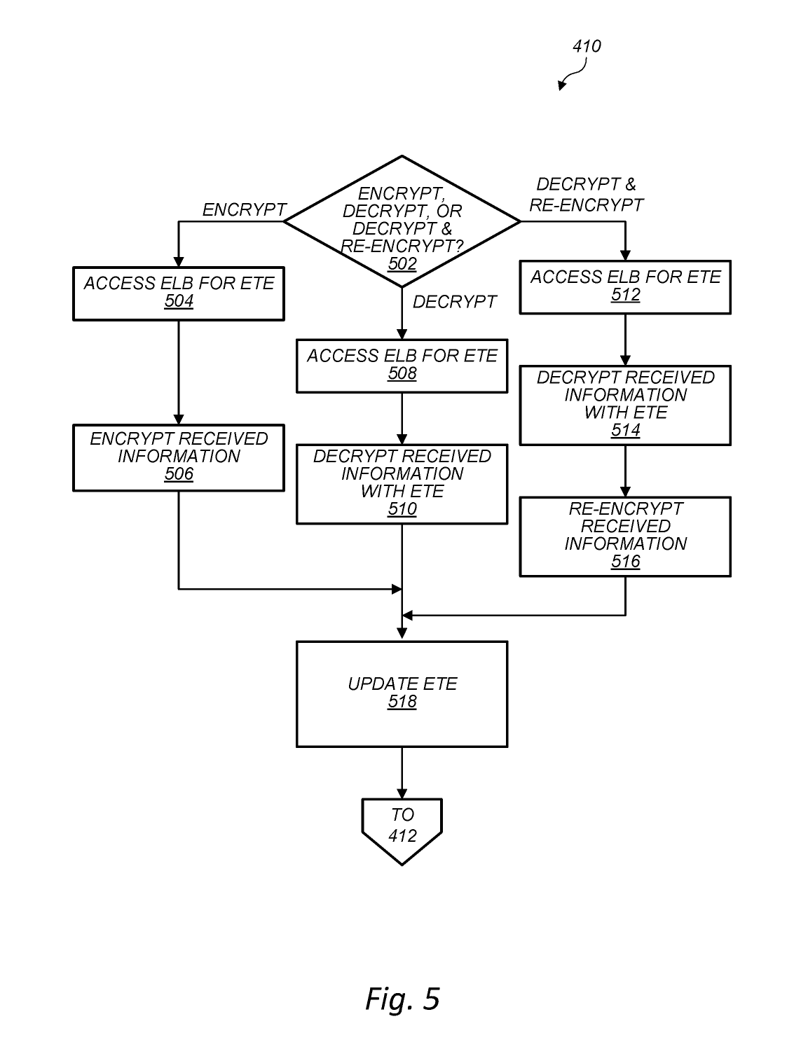

Referring now to FIG. 5, a flowchart illustrating one embodiment of a method of performing a cryptographic operation with an EMC is shown. At block 502, the EMC 130 determines which cryptographic operation to perform. The EMC 130 (e.g., using the cryptographic operation circuit 220) may encrypt the received information, decrypt the received information, or decrypt and re-encrypt the received information. As discussed herein, in some embodiments, the cryptographic operation circuit 220 may receive an indication of which cryptographic operation to perform. Alternatively, the cryptographic operation circuit 220 may access encryption information associated with the address of the data, the origin memory location, the destination memory location, or any combination thereof to determine which type of cryptographic operation to perform on the received data (e.g., by checking a flag, checking an indicator of an encryption algorithm associated with the received data, checking an indicator of an encryption key associated with the received data, etc.). Additionally or alternatively, the determination of which cryptographic operation to perform may be based in part on the address of the data, the origin memory location of the received information, the destination memory location of the received information, or any combination thereof. For example, the cryptographic operation circuit 220 may always decrypt received information if the origin memory location of the received information is in the L0 cache 124₀ and the destination memory location is the register file 122. Similarly, the cryptographic operation circuit 220 may always encrypt received information if the origin memory location of the received information is the register file 122 and the destination memory location is in the L0 cache 124₀.

Having determined to encrypt the received information, at block 504, the EMC 130 (e.g., using the cryptographic operation circuit 220) may access the encryption lookaside buffer (ELB) 230 to retrieve the encryption information (e.g., an ETE 232) associated with the received information, as discussed above with reference to FIG. 2. If the ELB 230 does not have a copy of the ETE 232 associated with the received information, the ELB 230 may access the encryption storage buffer (ESB) 240 to see of the ESB 240 has a copy of the ETE 232 associated with the received information. If neither the ELB 230 nor the ESB 240 have a copy of the ETE 232 associated with the received information, the cryptographic operation circuit 220 may return an encryption fault. Upon returning an encryption fault, the EMC 130 may invoke software to attempt to retrieve the ETE 232 for the received information from the memory hierarchy 120 or system memory hierarchy 300 and load it into the ESB 240, or create an appropriate ETE 232 if one cannot be retrieved.

Having accessed a copy of ETE 232 associated with the received information, at block 506, the EMC 130 (e.g., using the cryptographic operation circuit 220) may encrypt the received information in accordance with an encryption algorithm. If the EMC 130 includes hardware or software to perform multiple encryption algorithms (and a list of the multiple encryption algorithms), the EMC 130 may determine which encryption algorithm to use (e.g., randomly, based on the time, based on the origin memory location, based on the destination memory location, based on the previous encryption algorithm used, based on an address of the data, etc.). The EMC 130 may also determine an encryption key to use with the encryption algorithm if the algorithm uses a keyed encryption. This encryption key may be selected from a list of keys (e.g., randomly, based on the time, based on the origin memory location, based on the destination memory location, based on the previous encryption key used, etc.) or calculated (e.g., randomly, based on the time, based on the origin memory location, based on the destination memory location, based on the previous encryption key used, based on the address of the data, etc.). In various embodiments, the list of keys may be stored in the EMC 130. Alternatively, the list of keys may be stored in another circuit (e.g., a portion of the memory hierarchy 120). In some embodiments, the offset of the virtual address from the base of the virtual address “page” of the address of the data, the origin memory location, or the destination memory location may be used to salt the encryption algorithm. Additionally or alternatively, the EMC 130 may include hardware that may be used as a salt (e.g., a true random number generator). It will be understood that the process of encrypting the received information will not be substantially different if the information is already encrypted (i.e., the resulting second format will be multiply encrypted). The method may proceed to block 518.

At block 518, the EMC 130 may update an ETE for the data (e.g., for the destination memory location, the origin memory location, or an address of the data) by storing one or more of an indicator of the encryption algorithm (or multiple algorithms used if the second format is multiply encrypted) used, an indicator of the encryption key (or multiple keys used if the second format is multiply encrypted) used, and a cryptographic status indicator showing that the data at the destination memory location is encrypted (or multiply encrypted). In some embodiments, at block 518, the EMC 130 may also clear the ETE associated with the origin memory location. The method 400 may then continue to block 412 discussed herein.

Having determined to decrypt the received information, at block 508, the EMC 130 (e.g., using the cryptographic operation circuit 220) accesses the encryption lookaside buffer (ELB) 230 to retrieve the encryption information (e.g., an ETE 232) associated with the received information. If the ELB 230 does not have a copy of the ETE 232 associated with the received information, the ELB 230 may access the encryption storage buffer (ESB) 240 to see of the ESB 240 has a copy of the ETE 232 associated with the received information. If neither the ELB 230 nor the ESB 240 have a copy of the ETE 232 associated with the received information, the cryptographic operation circuit 220 may return an encryption fault. Upon returning an encryption fault, the EMC 130 may invoke software to attempt to retrieve the ETE 232 for the received information from the memory hierarchy 120 or system memory hierarchy 300 and load it into the ESB 240, or create an appropriate ETE 232 if one cannot be retrieved. Having accessed a copy of ETE 232 associated with the received information, at block 510 the cryptographic operation circuit 220 may decrypt the received information (e.g., by using the encryption key with the encryption algorithm to change the received information into a decrypted format). If the received information was multiply encrypted, the resulting information may still be encrypted, but with a layer of encryption removed. The method may proceed to block 518.

At block 518, the EMC 130 may update the ETE for the data (e.g., for the destination memory location, the origin memory location, an address of the data, or any combination thereof) by storing or changing a cryptographic status indicator to indicate that the data at the destination memory location is unencrypted. Additionally or alternatively, if the first format of the received information was multiply encrypted, the second format of the received information may also be encrypted but with one (or more) fewer layers of encryption. If the second format is still encrypted after block 510, the EMC 130 may store in the ETE 232 an indicator of the encryption algorithm (or multiple algorithms used if the second format is multiply encrypted) used, an indicator of the encryption key (or multiple keys used if the second format is multiply encrypted) used, and a cryptographic status indicator showing that the data at the destination memory location is encrypted (or multiply encrypted). In some embodiments, at block 518, the EMC 130 may also clear the ETE associated with the origin memory location. The method 400 may then continue to block 412 discussed herein.

Having determined to decrypt and then re-encrypt the received information, at block 512, the EMC 130 (e.g., using the cryptographic operation circuit 220) accesses the encryption lookaside buffer (ELB) 230 to retrieve the encryption information (e.g., an ETE 232) associated with the received information. If the ELB 230 does not have a copy of the ETE 232 associated with the received information, the ELB 230 may access the encryption storage buffer (ESB) 240 to see of the ESB 240 has a copy of the ETE 232 associated with the received information. If neither the ELB 230 nor the ESB 240 have a copy of the ETE 232 associated with the received information, the cryptographic operation circuit 220 may return an encryption fault. Upon returning an encryption fault, the EMC 130 may invoke software to attempt to retrieve the ETE 232 for the received information from the memory hierarchy 120 or system memory hierarchy 300 and load it into the ESB 240, or create an appropriate ETE 232 if one cannot be retrieved.

Having accessed a copy of ETE 232 associated with the received information, at block 514 the cryptographic operation circuit 220 may decrypt the received information (e.g., by using the encryption key with the encryption algorithm to change the received information into a decrypted format). If the received information was multiply encrypted, the resulting information may still be encrypted, but with a layer of encryption removed.

At block 516, the EMC 130 may re-encrypt the received information. If the EMC 130 includes hardware or software to perform multiple encryption algorithms, the EMC 130 may determine which encryption algorithm to use (e.g., randomly, based on the time, based on the origin memory location, based on the destination memory location, based on the previous encryption algorithm used, etc.). The EMC 130 may also determine an encryption key to use with the encryption algorithm if the algorithm uses a keyed encryption. This encryption key may be selected from a list of possible keys (e.g., randomly, based on the time, based on the origin memory location, based on the destination memory location, based on the previous encryption key used, etc.) or calculated (e.g., randomly, based on the time, based on the origin memory location, based on the destination memory location, based on the previous encryption key used, etc.). In some embodiments, the offset of the virtual address from the base of the virtual address “page” of the origin memory location or destination memory location may be used to salt the encryption algorithm. Additionally or alternatively, the EMC 130 may include hardware that may be used as a salt (e.g., a true random number generator). The method may proceed to block 518.

Having decrypted and re-encrypted the received information, at block 518, the EMC 130 may update the ETE for the data (e.g., for the destination memory location, the origin memory location, an address of the data, or any combination thereof) by storing one of more of an indicator of the encryption algorithm (or multiple algorithms used if the second format is multiply encrypted) used, an indicator of the encryption key (or multiple keys used if the second format is multiply encrypted) used, and a cryptographic status indicator showing that the data at the destination memory location is encrypted (or multiply encrypted). In some embodiments, at block 518, the EMC 130 may also clear the ETE associated with the origin memory location. The method 400 may then continue to block 412 discussed herein.

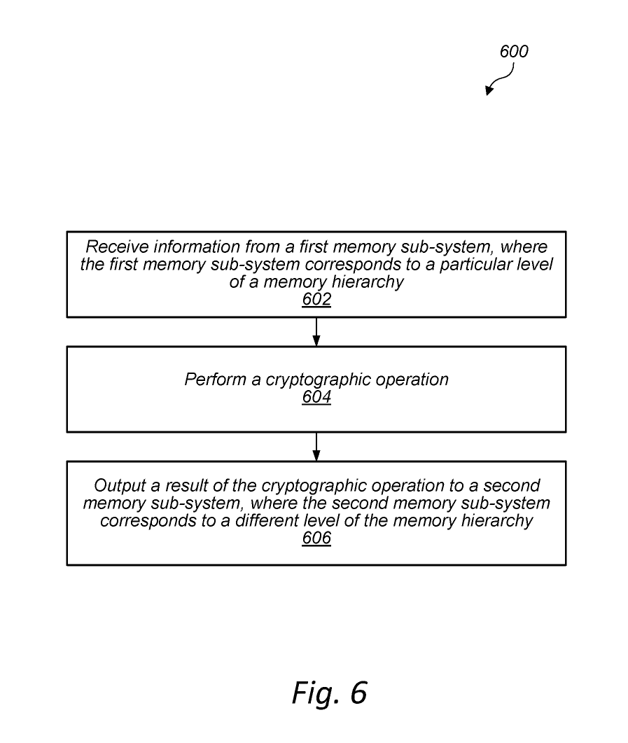

Turning now to FIG. 6, a flow diagram of a method 600 of performing a cryptographic operation is depicted. At 602, method 600 includes receiving information from a first memory sub-system. The first memory sub-system may correspond to a particular level of a memory hierarchy. For example, EMC 130 may receive information from L1 cache 124₁ of memory hierarchy 120.

At 604, method 600 includes performing a cryptographic operation. For example, EMC 130 may perform a cryptographic operation (e.g., encrypting, decrypting, or decrypting and encrypting) on the received information.

At 606, method 600 includes outputting a result of the cryptographic operation to a second memory sub-system, where the second memory sub-system corresponds to a different level of the memory hierarchy. For example, EMC 130 may output the result of the cryptographic operation to register file 122.

### Example Computer System

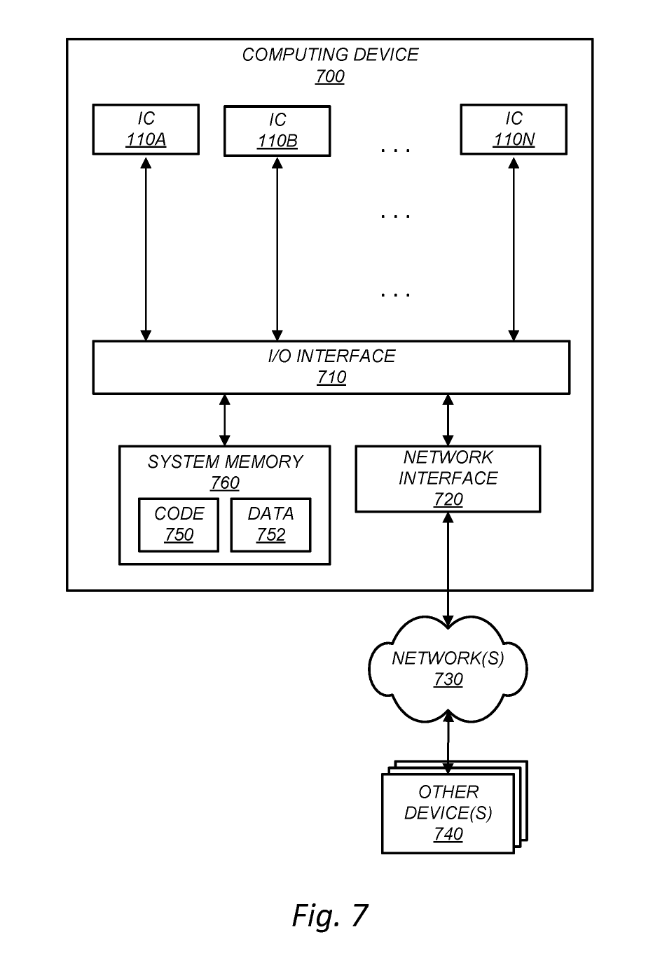

FIG. 7 illustrates a computing system configured to implement some or all of the hardware mechanisms and methods described herein, according to various embodiments. The computer system 700 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

In at least some embodiments, computer system 700 may include or be configured to access one or more computer-readable media, which may store program instructions suitable for implementing some of the methods, features and/or enhancements described herein. For example, computer system 700 may be configured to host one or more portions of a multithreaded, distributed, or concurrent application, threads of which may access various elements or nodes of a concurrent data structure. In the illustrated embodiment, computer system 700 includes one or more integrated circuits 110 (shown as 110a-110n) that are coupled to a system memory 760 via an input/output (I/O) interface 710. Computer system 700 further includes a network interface 720 coupled to I/O interface 710.

In various embodiments, computer system 700 may be a uniprocessor system including one integrated circuit 110 (including an execution unit 140) or a multiprocessor system including several integrated circuits 110 (e.g., two, four, eight, or another suitable number, each including an execution unit 140). The integrated circuits 110 may include any suitable execution units 140 capable of executing instructions. For example, in various embodiments, execution units 140 of the integrated circuits 110 may be general-purpose or embedded processors implementing any of a variety of instruction set architectures (ISAs), such as the x86, PowerPC, SPARC, or MIPS ISAs, or any other suitable ISA. In multiprocessor systems, each of integrated circuits 110 may commonly, but not necessarily, implement the same ISA.

System memory 760 may be configured to store program instructions and data accessible by integrated circuits(s) 110. In various embodiments, some or all of system memory 760 may correspond to external memory 160 of FIG. 1. In some embodiments, some portions of system memory 760 may be dedicated to a particular integrated circuit 110, while other portions of system memory 760 may be shared between (and accessible by) all of the integrated circuit 110 and/or with other computing devices 740. In various embodiments, system memory 760 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 760 as code (i.e., program instructions) 750 and data 752.

In various embodiments, a compiler, a multithreaded, distributed or concurrent application, a process for operating memory, and/or a library (and/or any individual sub-modules thereof) used in implementing the techniques described may each be implemented using any of various programming languages or methods. For example, in one embodiment, code for implementing a compiler, application, and/or library may be written in any of the C, C++, assembly, JAVA or other general-purpose programming languages, while in another embodiment, one or more of them may be written using a different, more specialized, programming language. Moreover, in some embodiments, a compiler, an application, and/or a library (and/or various sub-modules thereof) used in implementing the techniques described herein may each be implemented using a different programming language.

In one embodiment, I/O interface 710 may be configured to coordinate I/O traffic between integrated circuit 110, system memory 760, and any peripheral devices in the device, including network interface 720 or other peripheral interfaces. In some embodiments, I/O interface 710 may perform any necessary protocol, timing or other data transformations to convert data signals from one component (e.g., system memory 760) into a format suitable for use by another component (e.g., integrated circuit 110). In some embodiments, I/O interface 710 may include support for devices attached through various types of peripheral buses, such as a variant of the Peripheral Component Interconnect (PCI) bus standard or the Universal Serial Bus (USB) standard, for example. Also, in some embodiments some or all of the functionality of I/O interface 710, such as an interface to system memory 760, may be incorporated directly into integrated circuit 110.

Network interface 720 may be configured to allow data to be exchanged between computer system 700 and other computing devices 740 attached to a network or networks 730, such as other computer systems or devices. In some embodiments, system memory 760 may be connected to ICs 110A-N via network interface 720. In various embodiments, network interface 720 may support communication via any suitable wired or wireless general data networks, such as types of Ethernet network, for example. In some embodiments, network interface 720 may be a low-latency interface (e.g., an InfiniBand interconnect or another low-latency interface) over which multiple nodes of a distributed system (any or all of which may be implemented on a computing device similar to computer system 700) communicate with each other.

In some embodiments, system memory 760 may be one embodiment of a computer-readable (e.g., computer-accessible) medium configured to store program instructions and data, as described above, for implementing embodiments of the techniques described herein. However, in other embodiments, program instructions and/or data may be received, sent or stored upon different types of computer-readable media. Generally speaking, a computer-readable medium may include non-transitory storage media or memory media such as magnetic or optical media, e.g., disk or DVD/CD coupled to computer system 700 via I/O interface 710. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 700 as system memory 760 or another type of memory.

Further, a computer-readable medium may include transmission media or signals such as electrical, electromagnetic, or digital signals, conveyed via a communication medium such as a network and/or a wireless link, such as may be implemented via network interface 720. Portions or all of multiple computer systems such as that illustrated in FIG. 7 may be used to implement the described functionality in various embodiments; for example, software components running on a variety of different devices and servers may collaborate to provide the described functionality. In some embodiments, portions of the described functionality may be implemented using storage devices, network devices, or special-purpose computer systems, in addition to or instead of being implemented using general-purpose computer systems. The terms “computing device,” and “computer system,” as used herein, refers to at least all of these types of devices, and is not limited to these types of devices.

Various embodiments may further include receiving, sending, or storing instructions and/or data implemented in accordance with the foregoing description upon a computer-readable medium. Generally speaking, a computer-readable medium may include non-transitory storage media or memory media such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-readable medium may also include transmission media or signals such as electrical, electromagnetic, or digital signals, conveyed via a communication medium such as network and/or a wireless link.

The various methods as illustrated in the figures and described herein represent exemplary embodiments of methods. The methods may be implemented in software, hardware, or a combination thereof. In various ones of the methods, the order of the steps may be changed, and various elements may be added, reordered, combined, omitted, modified, etc. Various ones of the steps may be performed automatically (e.g., without being directly prompted by user input) and/or programmatically (e.g., according to program instructions), in some embodiments.

While various systems and methods have been described herein with reference to, and in the context of, specific embodiments, it will be understood that these embodiments are illustrative and that the scope of the disclosure is not limited to these specific embodiments. Many variations, modifications, additions, and improvements are possible. For example, the blocks and logic units identified in the description are for understanding the described embodiments and not meant to limit the disclosure. For example, actions, processes, methods, tasks or functions described herein as being performed by a hazard lookaside buffer may, in some embodiments, be performed by another component (e.g., a specialized store buffer) and vice versa. Additionally, functionality may be separated or combined in blocks differently in various realizations of the systems and methods described herein or described with different terminology.

These embodiments are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of examples that follow. Finally, structures and functionality presented as discrete components in the exemplary configurations may be implemented as a combined structure or component.

Although the embodiments above have been described in detail, numerous variations and modifications will become apparent once the above disclosure is fully appreciated. It is intended that the following claims be interpreted to embrace all such variations and modifications.

What is claimed is:

1. An apparatus comprising:
an integrated circuit including:
a first memory corresponding to a first memory level of a memory hierarchy;
a second memory corresponding to a second memory level of the memory hierarchy; and
an encryption management circuit (EMC) configured to:
receive information in a first format from the first memory;
perform a cryptographic operation to convert the information from the first format to a second format; and
output the information to the second memory.

2. The apparatus of claim 1, wherein the EMC is configured to perform the cryptographic operation using stored cryptographic information corresponding to a first memory address of the information in the first memory level, a second memory address of the information in the second memory level, or both.

3. The apparatus of claim 2, wherein the cryptographic information includes an indicator of an encryption algorithm and an indicator of an encryption key.

4. The apparatus of claim 3, wherein the first format is an encrypted format and the second format is an unencrypted format, and wherein the EMC is configured to perform the cryptographic operation by decrypting the information using the encryption algorithm and the encryption key specified by the stored cryptographic information to convert the information from the first format to the second format.

5. The apparatus of claim 3, wherein the first format is a doubly encrypted format and the second format is a singly encrypted format, and wherein the EMC is configured to perform the cryptographic operation by decrypting the information using the encryption algorithm and the encryption key specified in the stored cryptographic information to convert the information from the first format to the second format.

6. The apparatus of claim 1, wherein encryption management circuit (EMC) is configured to:
receive second information in the first format from the first memory level; and
based on a determination not to perform a cryptographic operation on the second information, output the second information to the second memory level without changing a format of the second information.

7. The apparatus of claim 6, wherein the first format is an unencrypted format.

8. The apparatus of claim 1, wherein the EMC is configured to:
update cryptographic information within the EMC corresponding to a memory address of the information in the second memory level to reflect performance of the cryptographic operation.

9. The apparatus of claim 1, wherein the first format is an unencrypted format and the second format is an encrypted format, and wherein the EMC is configured to:
perform the cryptographic operation by encrypting the information using an encryption algorithm and an encryption key; and
update cryptographic information corresponding to a memory address of the information in the second memory level by storing an indicator of the encryption algorithm and storing an indicator of the encryption key.

10. The apparatus of claim 1, wherein the EMC is configured to perform the cryptographic operation by using a particular cryptographic algorithm selected from a list of cryptographic algorithms and by using a particular encryption key selected from a list of encryption keys.

11. The apparatus of claim 1, further comprising:
a third memory corresponding to a third memory level of the memory hierarchy; and
a second EMC configured to:
receive information in the second format from the second memory;
perform a cryptographic operation to convert the information from the second format to a third format; and
output the information to the third memory.

12. The apparatus of claim 1, wherein the first memory level corresponds to a register file and second memory level corresponds to an L1 cache.

13. The apparatus of claim 1, wherein the first memory level corresponds to an L2 cache and the second memory level corresponds to an L1 cache.

14. A method comprising:
receiving, at an encryption management circuit within an integrated circuit of a computer system, information from a first memory sub-system of the integrated circuit, wherein the first memory sub-system corresponds to a particular level of a memory hierarchy of the computer system;
performing a cryptographic operation; and
outputting a result of the cryptographic operation to a second memory sub-system of the integrated circuit, wherein the second memory sub-system corresponds to different level of the memory hierarchy.

15. The method of claim 14, further comprising:
accessing a first buffer to retrieve a cryptographic key relating to the information,
wherein performing the cryptographic operation includes using the cryptographic key to decrypt the information.

16. The method of claim 15, further comprising:
determining that the first buffer does not store the cryptographic key relating to the information;
in response to the determining, accessing a second buffer storing the cryptographic key relating to the information; and
loading the cryptographic key relating to the information into the first buffer.

17. The method of claim 14, further comprising:
selecting an encryption algorithm from a list of encryption algorithms; and
determining an encryption key,
wherein performing the cryptographic operation includes encrypting the information using the encryption algorithm and the encryption key.

18. A system, comprising:
an integrated circuit, comprising:
a first memory corresponding to a first memory level in a memory hierarchy of the system;
a second memory corresponding to a second memory level in the memory hierarchy; and
an encryption management circuit (EMC) configured to perform a cryptographic operation on data received from the first memory and output a result of the cryptographic operation to the second memory; and
a third memory external to the integrated circuit and corresponding to a third memory level in the memory hierarchy, wherein the integrated circuit is configured to access the third memory, and
wherein the integrated circuit is configured to store data from memories external to the integrated circuit via a data path external to the EMC.

19. The system of claim 18, wherein the integrated circuit further comprises a first encryption buffer configured to store cryptographic information corresponding to a set of memory addresses.

20. The system of claim 19, wherein the third memory further comprises a second encryption buffer configured to store cryptographic information corresponding to the set of memory addresses, wherein the second encryption buffer is larger than the first encryption buffer.
